(19) United States
(12) Patent Application Publication
(10) Pub. No.: US 2023/0143540 A1
(43) Pub. Date: May 11, 2023

(54) SYSTEMS AND METHODS FOR GENERATING VISUAL REPRESENTATIONS OF CLIMATE HAZARD RISKS

(71) Applicant: Bank of Montreal, Toronto (CA)

(72) Inventors: Kian Kenyon-Dean, Toronto (CA); Michael Torrance, Toronto (CA)

(73) Assignee: Bank of Montreal, Toronto (CA)

(21) Appl. No.: 17/959,143

(22) Filed: Oct. 3, 2022

Related U.S. Application Data
(60) Provisional application No. 63/251,549, filed on Oct. 1, 2021.

(51) Int. Cl. G06Q 50/26; G06Q 50/16; G06F 3/04847

(52) U.S. Cl. CPC G06Q 50/265; G06Q 50/16; G06F 3/04847

(57) ABSTRACT

A system and method for generating visual representations of climate hazard risk identifies geographic regions associated with flood hazard risks or risks of other extreme weather events. Disclosed embodiments may identify geographic regions associated with climate hazard risk using geolocation data such as geo-coordinates or postal zones. In a climate hazard risk platform, a climate hazard dashboard generates dashboards and reports providing visual representations of climate hazards and real estate assets within a selected geographic region. These dashboards and reports enable users to understand risk in different scenarios, such as projections over various time frames, physical climate hazard types, current and future time frames, and probabilities of occurrence. The platform includes a cloud data warehouse and a business intelligence (BI) analytics component. A climate hazard risk map may overlay a map of estimated climate hazard and a map of real estate assets within the selected geographic region.

### CROSS-REFERENCE TO RELATED APPLICATION

The present application claims benefit of U.S. Provisional App. No. 63/251,549, filed Oct. 1, 2021, titled “Systems and Methods for Generating Visual Representations of Climate Hazard Risks,” which is incorporated by reference in its entirety.

### TECHNICAL FIELD

This application relates generally to climate hazard estimation, and more particularly to generating visual representations of climate hazard risks.

### BACKGROUND

By many accounts, flooding is the most costly type of natural disaster. For example, 2013 Toronto floods caused over $1 billion in property damage. As climate change continues to grow in impact, it is expected that extreme weather events including flooding will increase in frequency. In many geographic locations including Ontario, Canada, pluvial flooding is the most common type of flooding event. Pluvial flooding is characterized by the inundation of the urban environment as a result of rainfall overwhelming storm water management systems. Compared to fluvial flooding (associated with watercourse or river overflows) and coastal flooding (associated with lake or ocean overflows), many territories and municipalities may be least prepared to handle pluvial flooding.

Storm driven floods along major rivers and their tributaries have resulted in loss of life and billions of dollars in damages, as well as lost productivity to thousands of homes, farms, and businesses. As climate change progresses, severe weather events that may cause devastating flooding may become more frequent. In addition to flood hazard, climate change trends can pose physical climate risks associated with other forms of extreme weather such as fire and drought.

Up-to-date, high quality flood hazard maps and maps of other climate hazards are essential for informed urban planning, climate hazard preparation, mitigation, and climate risk response efforts. In addition, up-to-date maps of risks to property due to physical climate hazards, such as risks to private sector and public sector real property, are important for similar reasons. Billions of dollars per year is spent on flood and fire claims to governmental agencies and to private insurance, which increases costs for everyone and does not solve the existing problem. Related costs for repair and often substandard insurance products sold to potential flood or fire victims amount to a negative economic cash flow that affords only limited ex post facto relief.

What is needed is technology that addresses risks of flooding and other climate hazards before the event, as opposed to measures after a climate hazard event has ravaged an area. What is needed is technology that enable users to determine which geographical regions are most likely to experience extreme weather, and which real estate assets are most at risk.

### SUMMARY

What is needed is systems and methods that provide improved geographic mapping methods for flood hazard estimation and estimation of other physical climate hazards that draw from publically available data sources. What is needed is up-to-date maps of risks to property due to physical climate hazards, such as risks to private sector and public sector real properties. What is needed is high quality maps of climate hazard risks suitable for informed urban planning, hazard preparation, mitigation, and asset management.

In various embodiments, a system and method for generating visual representations of climate hazard risk identifies geographic regions associated with flood hazard risks or risks of other extreme weather events. Disclosed embodiments identify geographic regions associated with climate hazard risks using geolocation data such as geo-coordinates or postal zones. A global climate platform generates dashboards and reports providing visual representations of climate hazards and real estate assets within a selected geographic region. The global climate platform includes a climate hazard dashboard, a cloud data warehouse and a business intelligence (BI) analytics component. A climate hazard risk map may result from overlay of a map of estimated climate hazard and a map of real estate assets within the selected geographic region. Climate hazard risk dashboards and reports enable users to understand risk in different scenarios, such as projections over various time frames, physical climate hazard types, current and future time frames, and probabilities of occurrence.

In an embodiment, a computer-implemented method comprises generating, by the computer, a first graphical user interface dashboard configured to display on a client computing device a climate hazard selection map encompassing a first geographic region; receiving, by the computer, a geo-region selection and a climate hazard parameter selection, wherein the geo-region selection defines boundary of a second geographic region within the first geographic region; and in response to receiving the geo-region selection and the climate hazard parameter selection, generating, by the computer, a second graphical user interface dashboard configured to display on the client computing device a climate hazard risk map comprising a visual representation of climate hazard risks within the second geographic region corresponding to the climate hazard parameter selection and geolocations data for a plurality of real estate assets.

In another embodiment, a system comprises a non-transitory machine-readable memory that stores a plurality of real estate asset files including geolocations data for a plurality of real estate assets, and climate hazard data; and a processor, wherein the processor in communication with the non-transitory, machine-readable memory executes a set of instructions instructing the processor to: generate a first graphical user interface dashboard configured to display on a client computing device a climate hazard selection map encompassing a first geographic region; receive a geo-region selection and a climate hazard parameter selection, wherein the geo-region selection defines boundary of a second geographic region within the first geographic region; and in response to receiving the geo-region selection and the climate hazard parameter selection, generate a second graphical user interface dashboard configured to display on the client computing device a climate hazard risk map comprising a visual representation of climate hazard risks within the second geographic region corresponding to the climate hazard parameter selection and geolocations data for a plurality of real estate assets.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1 shows a web application architecture for a global climate platform, according to an embodiment.

FIG. 2 shows a backend architecture for data enrichment flow chart of geolocation data stored by a global climate platform, according to an embodiment.

FIG. 3 is a conceptual diagram of techniques to overlay data from a flood hazard map with data from a real estate asset map for visual representation of flood risk, according to an embodiment.

FIG. 4 shows visual representation of flood risk by overlaying a flood hazard map of a selected geographic region with a real estate asset map encompassing that region, according to an embodiment.

FIG. 5 is a view of a real estate asset map including a plurality of point locations, according to an embodiment.

FIG. 6 is a view of a real estate asset map including a plurality of geographic regions, according to an embodiment.

FIG. 7 is a view of a flood hazard selection map showing a control for selecting a geographic region for a flood hazard estimate and controls for selecting flood hazard estimation parameters, according to an embodiment.

FIG. 8 is a view of a flood hazard estimate map showing a flood hazard estimate based upon a geo-region selection and a climate hazard parameter selection, according to an embodiment.

FIG. 9 is a view of a flood hazard risk map resulting from overlay of a flood hazard estimate map with a real estate asset map in which various point locations represent geolocations of branches of a sponsoring enterprise, according to an embodiment.

FIG. 10 is a view of a flood hazard risk map displaying metadata from a flood hazard estimate within a real estate asset map representing geo-regions of residential mortgage assets of a sponsoring enterprise, according to an embodiment.

FIG. 11 is a view of summary analysis chart of flood hazard exposure of residential mortgage assets of a sponsoring enterprise, according to an embodiment.

FIG. 12 illustrates a method for generating visual representations of climate hazard risk, according to an embodiment.

### DETAILED DESCRIPTION

References will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

Embodiments disclosed herein apply an innovative approach to visual representation of flood hazard risks and risks of other physical climate hazards. A climate hazard risk platform employs geolocation data to determine at a very high resolution what geographical regions are most likely to experience flooding or other extreme weather. In an embodiment, the platform enables users to determine which assets are most at risk, e.g., in a portfolio of real estate assets. Users may include owners or others having an interest in real estate properties included in one or more asset portfolios.

Disclosed embodiments include a platform that encapsulates physical climate risk posed to real estate assets of interest to an enterprise. The enterprise may have a property interest, a financial interest, beneficial interest, or other in assets. Assets of interest may be included in one or more real estate asset portfolios of the enterprise. The platform can be useful to various lines of business. Assets of interest to the enterprise may include a wide range of asset types, such as office buildings, mines, farms, factories, and mortgages. Example use cases for banks and other financial institutions include sustainability strategies such as “green” pricing in mortgage lending, improving precision of a financial institution's stress testing, and risk models.

Disclosed embodiments may identify geographic regions associated with climate hazard risk using geolocation data including geo-coordinates. Disclosed embodiments may identify geographic regions associated with climate hazard risk using geolocation data that define geographic boundaries. Disclosed embodiments may identify point locations associated with climate hazard risk using geolocation data including latitude/longitude values.

Disclosed embodiments may identify geographic regions associated with flood hazard risks or risks of other extreme weather events using geolocation data including respective postal codes or collections of proximate postal codes. Such geographic regions are also herein referred to as postal zones. Disclosed embodiments may identify geographic regions associated with collections of proximate postal zones based on forward sortation area (FSA). The FSA may designate a geographical unit based on the first three characters in a Canadian postal code. All postal codes that start with the same three characters are together considered an FSA. Additionally, disclosed embodiments may identify geo-coordinates associated with centers of postal zones, and geo-coordinates defining boundaries of postal zones.

A climate hazard dashboard may display visual representations that may provide climate insights across multiple climate hazard types for any property or asset encompassed by the system. The climate hazard dashboard may generate dashboards and reports. These dashboards and reports enable users to understand risk in different scenarios, such as projections over various time frames, physical climate hazard types, current and future time frames, and probabilities of occurrence.

Disclosed embodiments include architecture for a platform that encapsulates physical climate risk across various asset portfolios. An illustrative architecture includes a cloud host system for a climate risk platform, also herein called global climate platform (“GCP”) or cloud environment. The cloud host system may be a third-party cloud. A climate engine deployed on the GCP applies geospatial modeling climate algorithms to estimate physical climate hazards associated with geographic regions. The climate engine may be a third-party application. In an embodiment, the climate engine provides an API to which GCP passes geolocation data and then receives climate hazard data for associated geographic regions or geolocations. In an example, GCP passes latitude-longitude point locations to the climate engine and receives climate hazard features for the associated point locations.

The GCP components include a cloud data warehouse. In an embodiment, the cloud data warehouse is hosted on the cloud environment and hosts large portfolio datasets. Features of the cloud data warehouse may include machine learning models for online prediction. These machine learning models may employ database queries, such as SQL queries, to retrieve and/or update data. In an embodiment, the cloud data warehouse includes in-memory analytics to perform in-place analysis.

The cloud data warehouse may include a plurality of data instances, e.g., in the form of data tables. In an example, primary data tables include branch office assets associated with branch offices of an enterprise, managed real estate associated with third party assets managed by an enterprise, and climate hazards. Data instances may include multiple instances of a given type of table, such as branch office asset tables for branch offices in U.S. and Canada, respectively. Other tables may include boundaries/coordinates/postal codes tables; e.g., tables of latitude/longitude centers of US postal codes and Canadian postal codes.

The cloud data warehouse may be enriched via offline processing jobs. In an example of data enrichment, each asset's physical location may be passed into climate engine. Data enrichment may add new tables to the cloud data warehouse. In an embodiment, data enrichment employs a cloud function to wrap around the climate engine API. For each asset, the cloud functions may receive as input an asset ID and asset geolocation data such as latitude/longitude coordinates, boundary coordinates, or postal code. Data enrichment function may employ a static geocoder dataset on the GCP to convert postal code to latitude/longitude boundary coordinates. Data enrichment may pass this data to the climate engine, possibly via multiple API calls in order to cover all scenarios, future year projections, and return periods. The function writes the results into a cloud data warehouse table for subsequent action by the Business Intelligence Analytics component.

GCP components may further include a front end, also referred to herein as a climate hazard dashboard. In an embodiment, the climate hazard dashboard incorporates interactive dashboards. Interactive dashboards may include selectable links associated with graphical user interface (GUI) objects or text elements of the dashboard. Activation of a selectable link may access a new dashboard page. Activation of a selectable link may activate a GUI control element such as a drop down list or menu.

The climate hazard dashboard integrates with the cloud data warehouse in generating visual representations of climate hazard risks. These visual representations may provide users with climate insights across multiple hazard types (flooding, wildfire, earthquake, etc.) for any property or asset encompassed by the system. For example, these visual representations may encompass a portfolio of assets of interest to a sponsoring enterprise. In an embodiment, dashboards and reports enable users to understanding risk in different scenarios, such as projections over various time frames, physical climate hazard types, current and future time frames, and probabilities of occurrence.

In an embodiment, GCP components include a business intelligence (BI) analytics component. This component acts as an intermediary between cloud data warehouse and the climate hazard dashboard. BI analytics acts on data from cloud data warehouse to perform functions such as authentication, data analytics, and construction of the climate hazard dashboard. In an embodiment, BI analytics receives data structures and business rules as inputs. In an embodiment, BI analytics includes database query builders. In an embodiment, BI analytics uses a machine learning model to construct SQL queries against a particular database. BI analytics may provide database query outputs such as query results and GUI data visualizations. In an embodiment, BI analytics component includes a dashboard tool that may be employed to build content for the climate hazard dashboard. A BI analytics dashboard tool may act upon data from cloud data warehouse data tables, including tables resulting from data enrichment, in order to build climate hazard dashboard content.

In an embodiment, the cloud based GCP communicates via a network with on-premises databases of a sponsoring enterprise. The on-premises databases store portfolio data for properties or assets to be processed by the GCP. In an example, this data includes branch operations assets, e.g., a dataset of branch offices or facilities of the enterprise, and managed real estate assets, e.g., mortgages of residential real properties. This data may include asset IDs and geolocation data for each of the assets in one or more portfolios. The on-premises databases may upload portfolio spreadsheets or data tables to the GCP to be stored by the cloud data warehouse. The system may include automated data export from the on-premises databases to the GCP, e.g., via SQL server. The system may include data enrichment functions for data received from the on-premises databases.

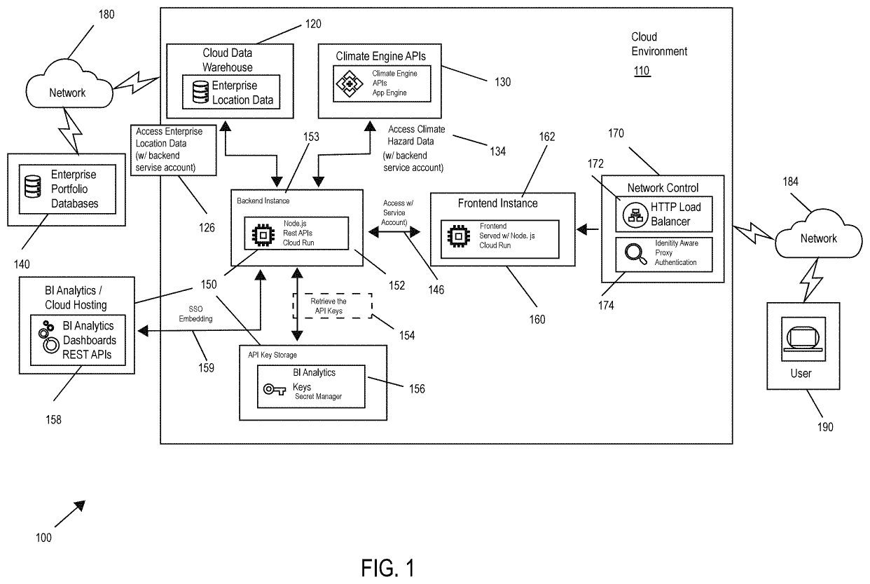

FIG. 1 shows a web application architecture for a global climate platform (GCP) 100. GCP 100 includes components for estimating physical climate hazard, and for generating visual representations of climate hazard risks posed to real estate assets of interest to an enterprise. These components are hosted within a cloud environment 110, which may be a third party cloud. Components may include cloud data warehouse 120, climate engine API 130s, BI analytics components 150, and front end/climate hazard dashboard 160.

The GCP 100 may be hosted on one or more computers (or servers), and the one or more computers may include or be communicatively coupled to one or more databases including databases of a sponsoring entity and third party databases. The GCP 100 can be executed by a server, one or more server computers, authorized client computing devices, smartphones, desktop computers, laptop computers, tablet computers, PDAs, and other types of processor-controlled devices that receive, process, and/or transmit digital data. The GCP 100 can be implemented using a single-processor system including one processor, or a multi-processor system including any number of suitable processors that may be employed to provide for parallel and/or sequential execution of one or more portions of the techniques described herein. The GCP 100 may perform these operations as a result of central processing unit executing software instructions contained within a computer-readable medium, such as within memory. In one embodiment, the software instructions of the system are read into memory associated with the GCP 100 from another memory location, such as from a storage device, or from another computing device via communication interface. In this embodiment, the software instructions contained within memory instruct the GCP 100 to perform processes described below. Alternatively, hardwired circuitry may be used in place of, or in combination with, software instructions to implement the processes described herein. Thus, implementations described herein are not limited to any specific combinations of hardware circuitry and software.

In an embodiment, cloud environment 110 incorporates containers, packages of software that contain all of the necessary elements to run in any environment. Containers virtualize the operating system and run anywhere, from a private data center to the public cloud. In an embodiment, cloud environment 110 may run containers that can be invoked via requests or events.

In various embodiments, GCP 100 extracts information from internal databases, and information from external third party information services. Databases are organized collections of data, stored in non-transitory machine-readable storage. In an embodiment, the databases may execute or may be managed by database management systems (DBMS), which may be computer software applications that interact with users, other applications, and the database itself, to capture (e.g., store data, update data) and analyze data (e.g., query data, execute data analysis algorithms). In some cases, the DBMS may execute or facilitate the definition, creation, querying, updating, and/or administration of databases. The databases may conform to a well-known structural representational model, such as relational databases, object-oriented databases, and network databases. Database management systems include MySQL, PostgreSQL, SQLite, Microsoft SQL Server, Microsoft Access, Oracle, SAP, dBASE, FoxPro, IBM DB2, LibreOffice Base, and FileMaker Pro. Database management systems also include NoSQL databases, i.e., non-relational or distributed databases that encompass various categories: key-value stores, document databases, wide-column databases, and graph databases.

In various embodiments, a cloud based GCP 100 communicates via network 180 with on-premises databases 140 of a sponsoring enterprise, also called enterprise portfolio databases. The on-premises databases store portfolio data for properties or assets to be processed by the GCP. On-premises databases 140 may upload portfolio spreadsheets or data tables to the GCP to be stored by the cloud data warehouse 120. The system may include automated data export from the on-premises databases to the GCP, e.g., via SQL server. The GCP may include data enrichment functions for data received from the on-premises databases.

In an embodiment, BI analytics API 150 may be a collection of RESTful operations 152, 156, 158. REST is acronym for REpresentational State Transfer. These operations enable GCP to employ various database functions in GCP applications, such as creating, reading, updating, and deleting records within a resource. BI analytics backend data instance 152 may create a node project file Node.js 153 via cloud run. The node project file is also herein referred to as backend data instance file or simply data instance. Backend data instance 152 can read data from cloud data warehouse 120 and/or climate engine API 130, which may be accessed via backend service account. Backend data instance 152 can access enterprise access geolocation data from cloud data warehouse 120, and can access climate hazard data from climate engine API 130.

BI analytics secret manager 156 may employ key security practices for database security. REST API's may retrieve API keys 154 to secure access between the BI analytics application 150 and the cloud data warehouse 120. BI analytic dashboards creates customized visualizations for use in the GCP's front end/climate hazard dashboard 160. BI analytics dashboards may be customized for compatibility with front end/climate hazard dashboard 160.

Front end/climate hazard dashboard 160 creates a frontend instance 160 based upon backend data instance 152, e.g., via front end web API served with node project file Node.js 162. The front end of GCP communicates via network 184 with a user device 190. These communications are regulated by network control 170, which may include HTTP load balancer 172 and authentication components. In an embodiment, user device 190 connects to GCP via identity aware proxy (IAP) authentication 174.

Networks 180, 184 may employ various modes of communications such as wireless communications, wired communications, and combinations of the same. In various embodiments, GCP communications over networks 180, 184 may use any of the following communication protocols, among others: TCP-IP (Transmission Control Protocol/Internet Protocol); UDP (User Datagram Protocol); VoIP (Voice over IP); SIP (Session Initiation Protocol); Telnet; SSH (Secure Shell protocol), CAP (Common Alerting Protocol), HTTP (Hypertext Transfer Protocol), SMTP (Simple Mail Transfer Protocol), or SNMP (Simple Network Management Protocol).

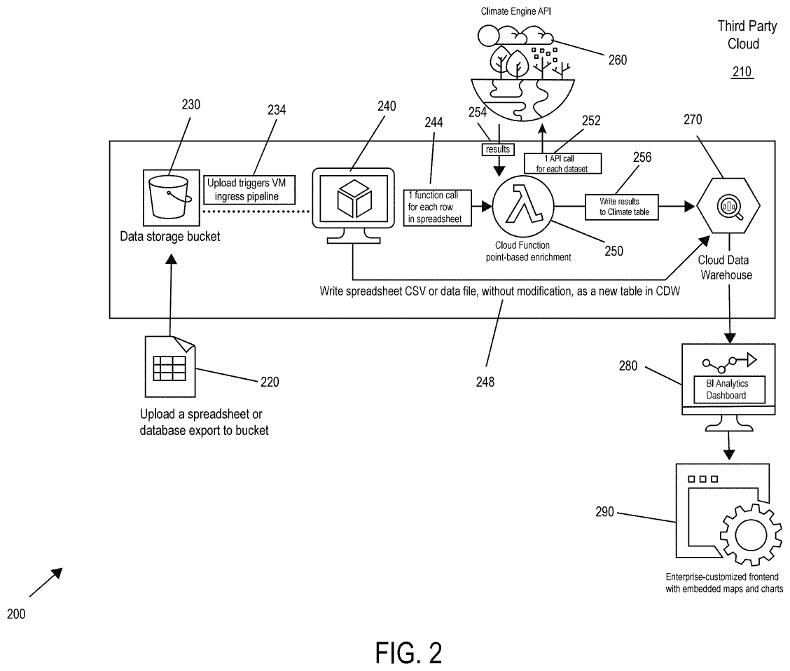

FIG. 2 shows a data analytics backend architecture 200 for data enrichment of geolocation data stored by GCP 100. In an embodiment, the data enrichment flow chart 200 feeds a large volume of geolocations data into climate engine API 260, and writes climate engine API results into a cloud data warehouse 270 database for later analysis. Data enrichment architecture 200 may be hosted on a third party cloud 210. At 220 a manual user operation or automated data export uploads a spreadsheet or data file to data storage bucket 230. This upload triggers 234 a virtual machine (VM) ingress pipeline with I/O via web interface 240.

A first branch of the data ingress flow chart writes 248 a spreadsheet CSV or an exported database file, without modifications, as a new table in the cloud data warehouse 270.

A second branch of the data ingress flow chart initiates 244 a function call for each row of an ingested spreadsheet or data file to route data to cloud function point-based enrichment module 250. Enrichment module 250 sends data 252 to climate engine API 260 with one API call for each dataset. Dataset(s) 252 may include single API call, or multiple calls to cover multiple scenarios, projection time periods, or return periods. Climate engine API 260 enriches point-based geolocation data with climate hazard data and returns results 254 to cloud function point-based enrichment module 250. The pipeline writes 256 the results to a climate table of cloud data warehouse 270.

Data enrichment pipeline 200 may incorporate other data enrichment functions for geolocations data. In an embodiment, pipeline 200 converts a postal code to latitude/longitude boundary using static geocoder data stored in the system.

Once geolocations data and enriched geolocations data have been written into tables in cloud data warehouse 270, these data may be analyzed and used to generate dashboards and reports. In an embodiment, the pipeline applies BI analytics dashboard 280 to create climate hazard risk maps and charts that are embedded in enterprise-customized frontend 290. A user may access frontend 290 to generate visual representations of climate hazard risk, e.g., on demand or via scheduled reports.

In an example, a financial services enterprise fed about 400,000 geolocations of mortgages of interest to the enterprise into the pipeline 200 of FIG. 2. Geolocation data included postal code data and point-based geolocation data. Ingested geolocation data was enriched using a flood hazard estimation database, then analyzed using flood risk algorithms to determine that about 7,700 mortgages were located in areas of very high flood risk.

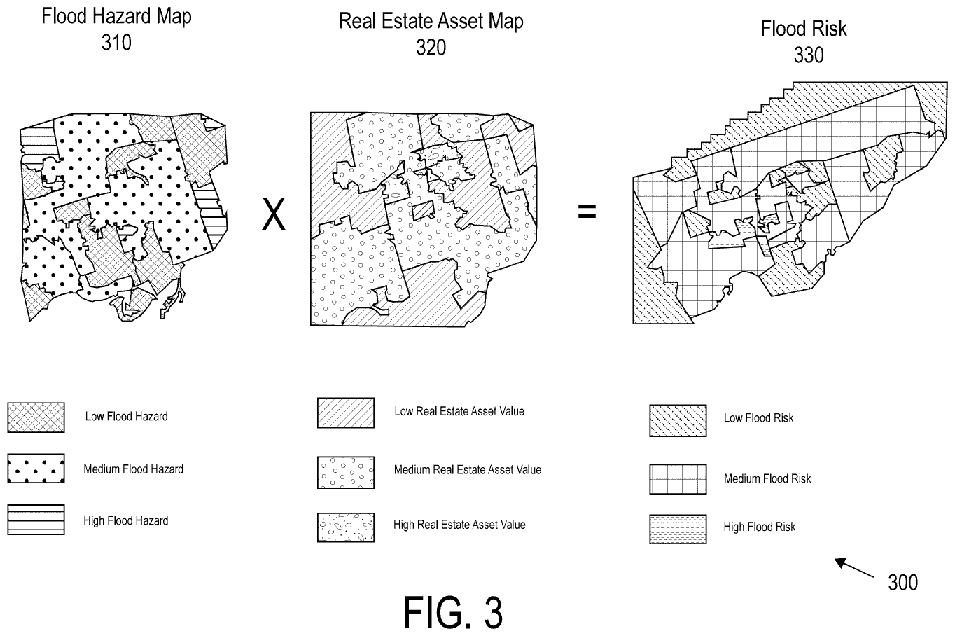

As shown in the conceptual diagram of FIG. 3, flood risk analysis may use geographic mapping techniques to overlay data from a flood hazard map 310 with data from a real estate asset map 320 to create visual representations of flood risk 330. Flood hazard map 310 may include low flood hazard geo-regions, medium flood hazard geo-regions, and high flood hazard geo-regions. Real estate asset map 320 may display low real estate value geo-regions, medium real estate value geo-regions, and high real estate value geo-regions. Based on mapping flood hazard geolocation data in map 310 to real estate asset value geolocation data in map 320, flood risk map 330 may include low flood risk geo-regions, medium flood risk geo-regions, and high flood risk geo-regions.

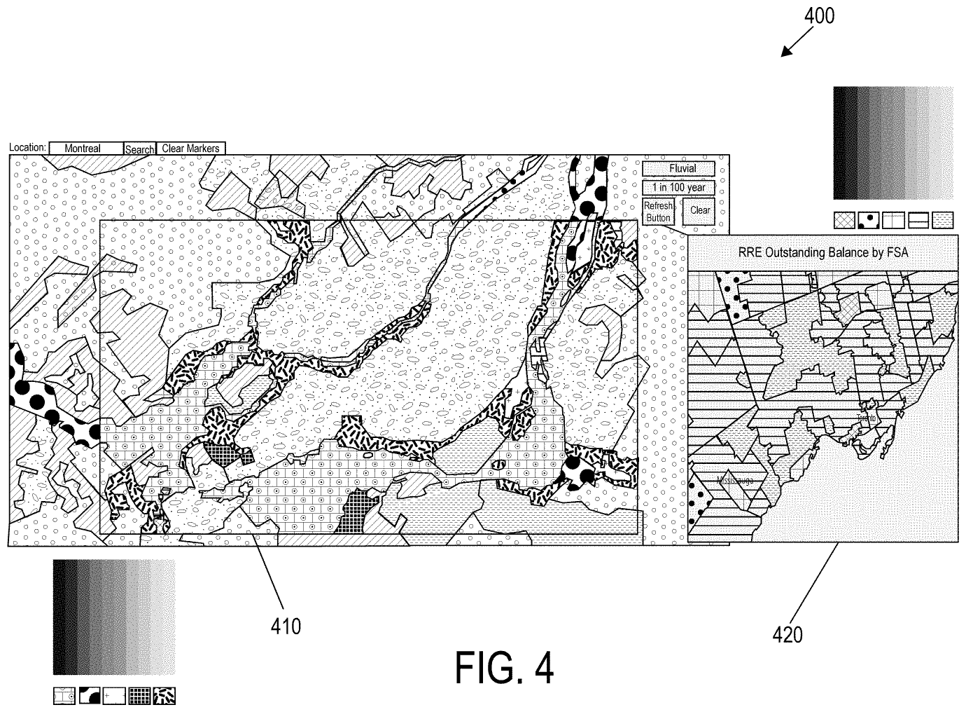

FIG. 4 shows mapping based risk analysis 400 to overlay a flood hazard map 410 of a selected geographic region 414 with a real estate asset map 420 encompassing that geographic region. In an embodiment, GCP 100 may generate an overlay of flood hazard estimation data for flood hazard map 410 with geo-location data for real estate asset map 420 with via data inputs 126, 134 to backend data instance 152. GCP 100 may generate a flood hazard risk map representing an overlay of these data sets via frontend data instance 160. In an embodiment, the flood hazard risk map provides spatial visualization of geo-regions having relatively high probabilities of flooding. In an embodiment, the flood hazard risk map displays metadata describing flood hazard risks associated with given geographic regions or geo-locations associated with real property assets.

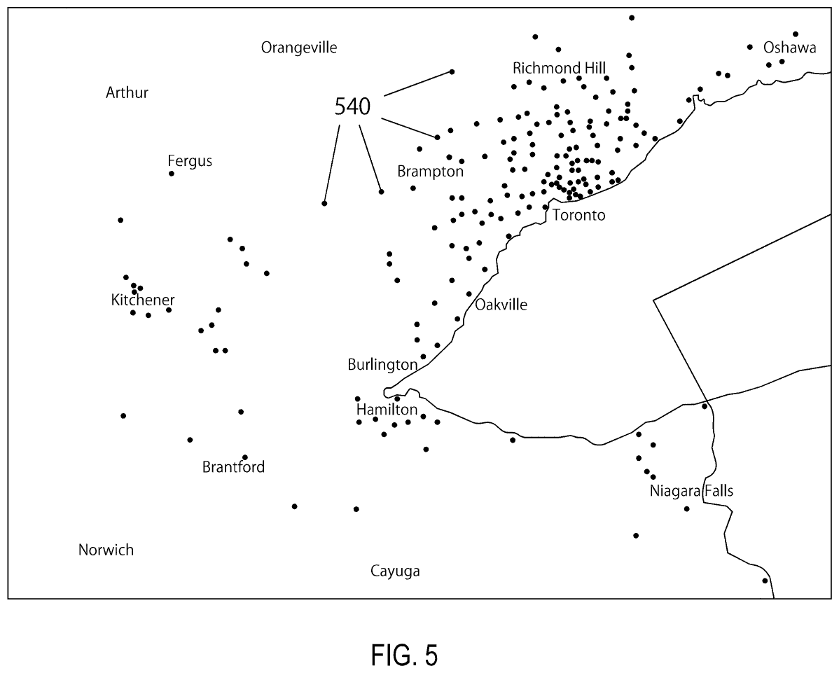

FIG. 5 shows a real property asset map 500 including a plurality of latitude-longitude point locations 540. In an embodiment, point locations 540 represent geolocations of branches of a sponsoring enterprise, such as bank branches.

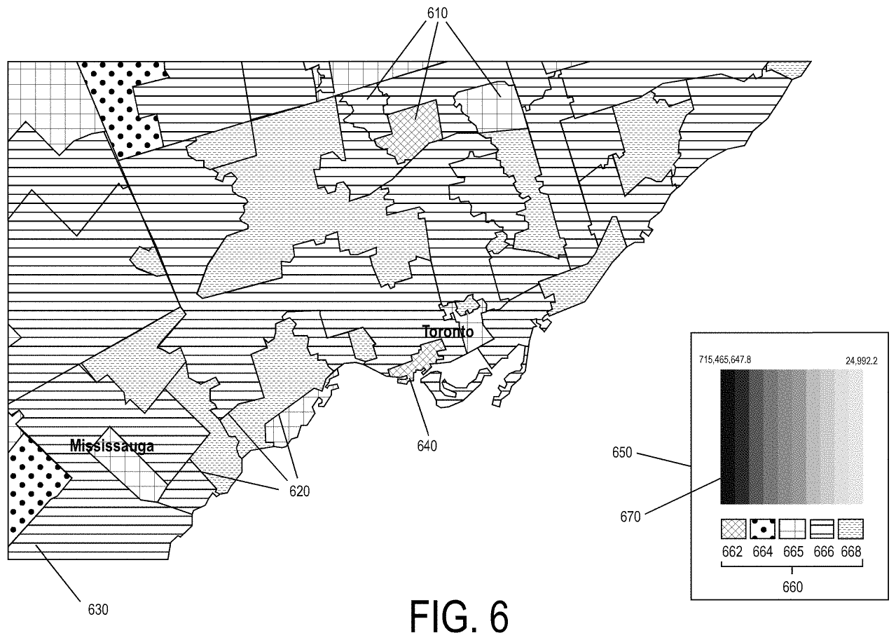

FIG. 6 shows a real property asset map 600 with a plurality of geographic regions 610. In an embodiment, geographic regions 610 are postal zones. Geographic regions may be defined by geo-locations of boundaries 620. Geographic regions 610 include visual coding 630 representing real estate asset values. A legend 650 includes a set of five discrete visual patterns 660 that represent asset values ranging from highest asset value geo-regions to lowest asset value geo-regions within map 600. Individual visual patterns 662, 664, 665, 666, and 668 correspond to sub-ranges of real estate asset value used in visual coding of geo-regions 610 in the map. Legend 650 also includes a heat map 670. In a heat map, a gradient of hues or intensity values may represent a range of asset values. Here, the heat map is a grayscale palette 670 and is not used in visual coding of geo-regions in FIG. 6. In an embodiment, asset values represent values of residential mortgage assets within respective geo-regions. For example, geo-region 640 may include a high residential mortgage asset value representing relatively high-value vulnerability to climate hazard risk.

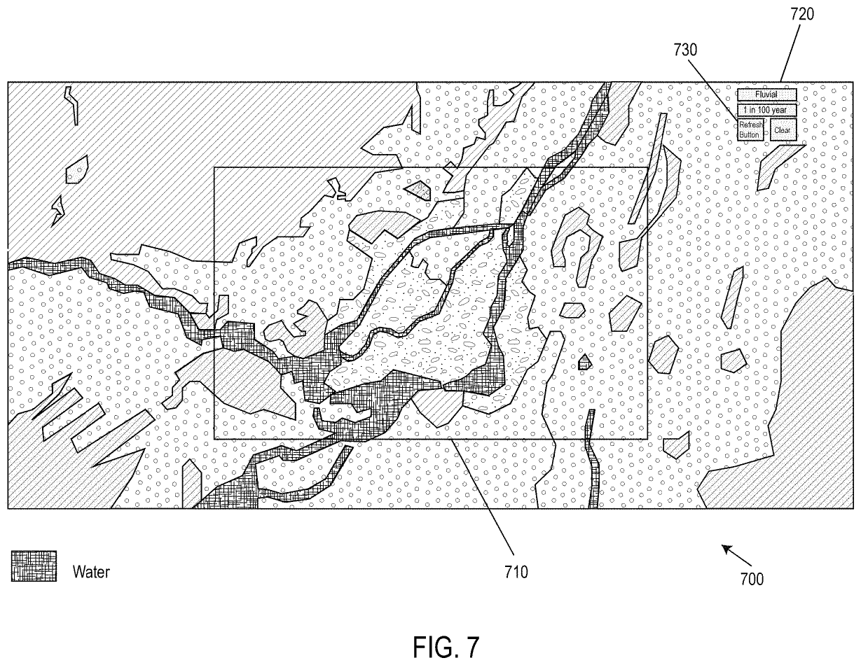

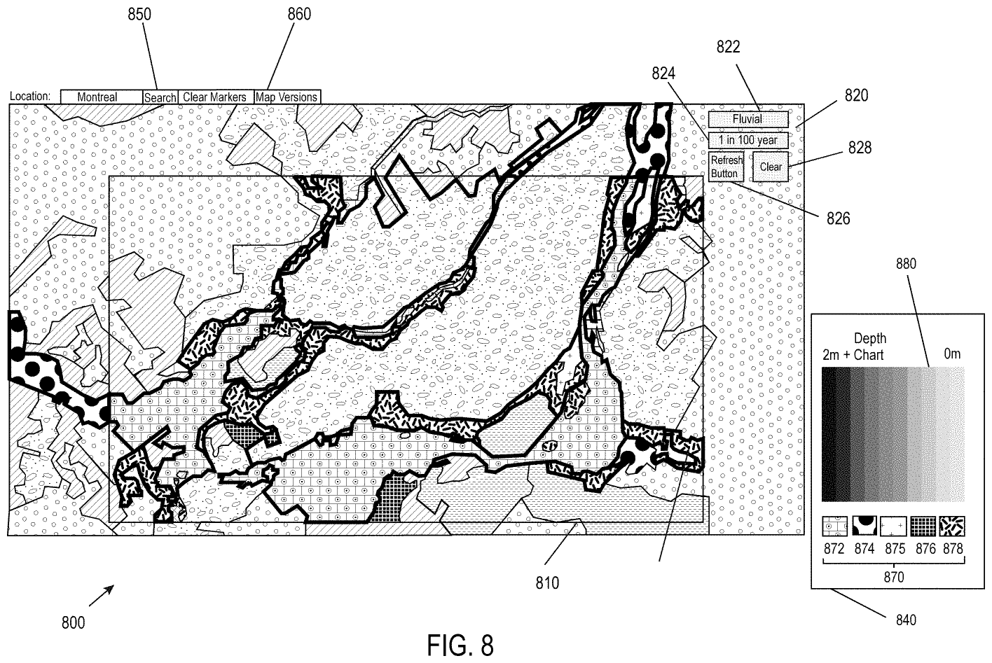

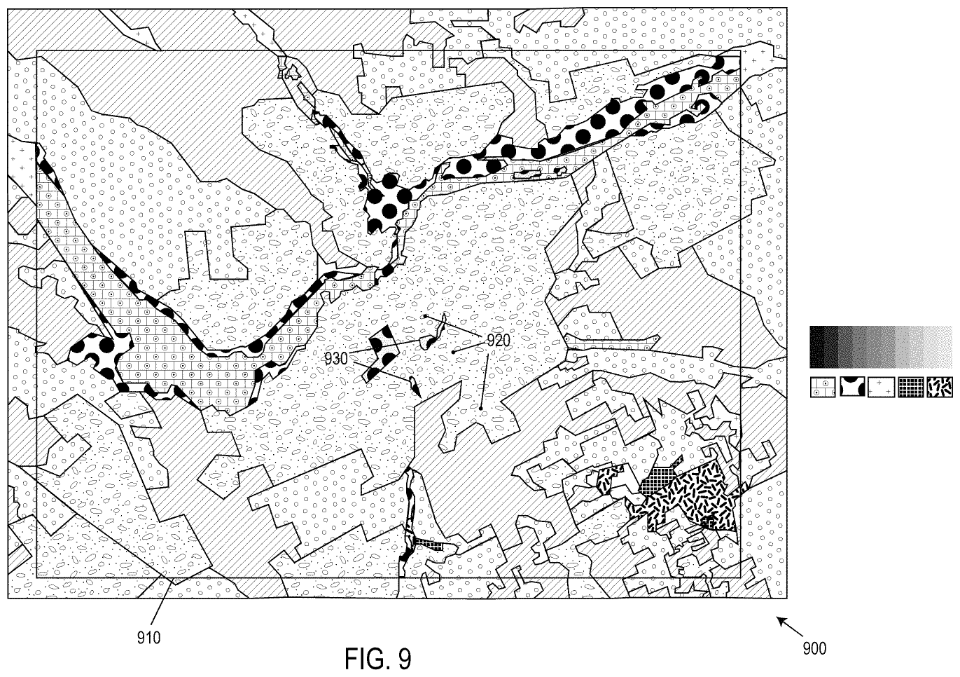

FIG. 7 shows a flood hazard selection map 700 including controls for selecting and generating a flood hazard estimate. Map 700 enables a user to select a geo-region selection and a climate hazard parameter selection. Map 700 includes a GUI control 710 for selecting a geo-region selection, e.g., latitude and longitude boundaries of a geographic region in which a flood hazard estimate is to be generated. Controls 720 select a climate hazard parameter selection, e.g., parameters of a flood hazard estimate to be generated. Details of controls for selecting parameters of a flood hazard estimate are described with reference to FIG. 8. Touch button 730 generates a flood hazard estimate map based on the selections.

FIG. 8 illustrates a flood hazard estimate map 800 generated based upon a geo-region selection and a climate hazard parameter selection. Map 800 displays a flood hazard estimate within latitude and longitude limits of geographic region box 810. Controls 820 for selecting parameters of the flood hazard estimate include a flood hazard type control 822 to indicate type of flooding to be included in the estimate. For example, flood type control 822 may be used to select fluvial flooding (river floods), pluvial flooding (surface water floods), or coastal flooding (associated with lake or ocean overflows). Flood probability control 824 may be used to select probability that flood will happen over a current or future time frame. For example, a 1 in 10 year flood has a probability of happening once every 10 years. Refresh button 826 may be used to generate a new map based on entered or updated parameters. Clear button 828 may clear entered parameters.

Other controls may be accessed via search tab 850 and map versions tab 860. In an embodiment, map versions tab 860 may be used to select among different versions of a map or to select among different maps within a set of maps. In various embodiments, map versions tab 860 may access control elements such as drop down lists or menus to select one or both climate hazard estimate maps and real estate asset maps. Map versions tab 860 may be used to select climate hazard risk maps or to customize such maps, e.g., based on overlays of climate hazard estimate maps and real estate asset maps.

Map 800 displays geographic areas of flood hazard within geo-region box 810. Map 800 indicates flood hazard geo-regions using boundaries of increased thickness. Depth chart legend 840 shows a visual coding scheme representing different depths of flood hazard. Legend 840 includes a set of five discrete visual patterns 870 that representing flood hazard depths ranging from 0 m to 2.0 m+. Individual visual patterns 872, 874, 875, 876, and 878 correspond to sub-ranges of flood hazard depth used in visual coding of flood hazard geo-regions. Legend 840 also includes a heat map 880. In a heat map, a gradient of hues or intensity values may represent different depths of flood hazard. Here, the heat map is a grayscale palette 880 and is not used in visual coding of geo-regions in FIG. 8.

Map 900 illustrates flood hazard risk map resulting from overlay of a flood hazard estimate map with a real property asset map in which various point locations represent geolocations of branches of a sponsoring enterprise. Flood hazard risk map 900 shows point locations of branches 920 juxtaposed with areas 930 of flooding hazard within selected geographic region 910. Map 900 enables users to visualize branches of a sponsoring enterprise that are more vulnerable to flood hazard risk defined by selected flood hazard estimation parameters. Flood hazard risk map is an example of a climate hazard risk map providing spatial visualization of geo-regions having relatively high probability of climate hazard.

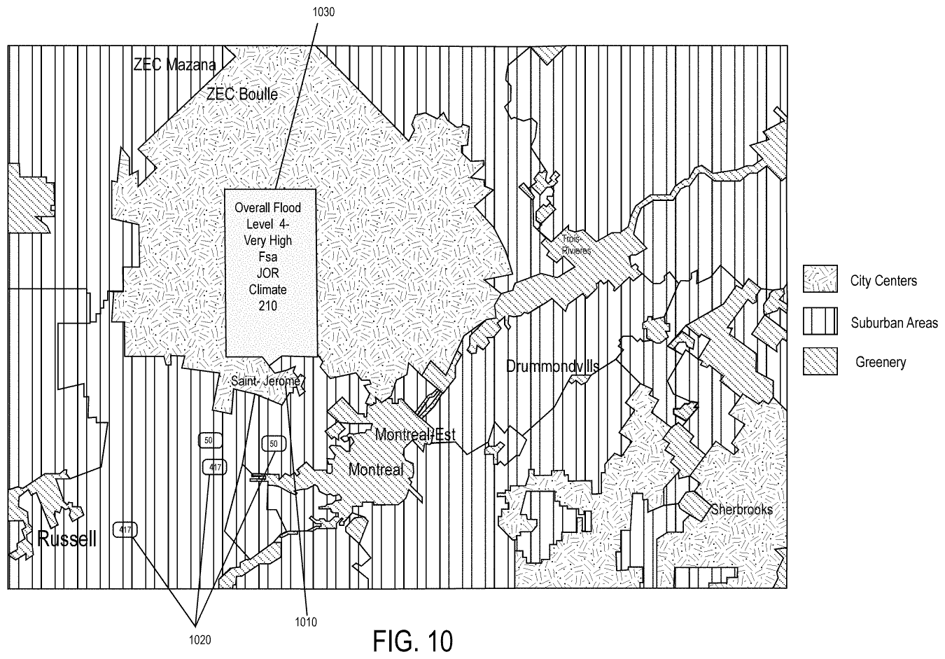

FIG. 10 is a representative view of a flood hazard risk map 1000 resulting from overlay of a flood hazard estimate map with a real property asset map representing geo-regions of residential mortgage assets of a sponsoring enterprise, according to an embodiment. Flood hazard risk map 1000 is an example of a map displaying metadata describing flood hazard risks associated with given geographic regions or geo-locations associated with real estate assets. Flood hazard risk map 1000 shows geo-regions 1010 corresponding to respective FSAs. Map 1000 displays number boxes 1020 representing number of residential mortgage assets exposed to flooding in each FSA. Map 1000 is interactive, enabling display of a drop down menu 1030 showing flood risk data for a selected FSA. Flood risk data menu 1030 displays an overall flood risk level of 4—very high—for a selected FSA.

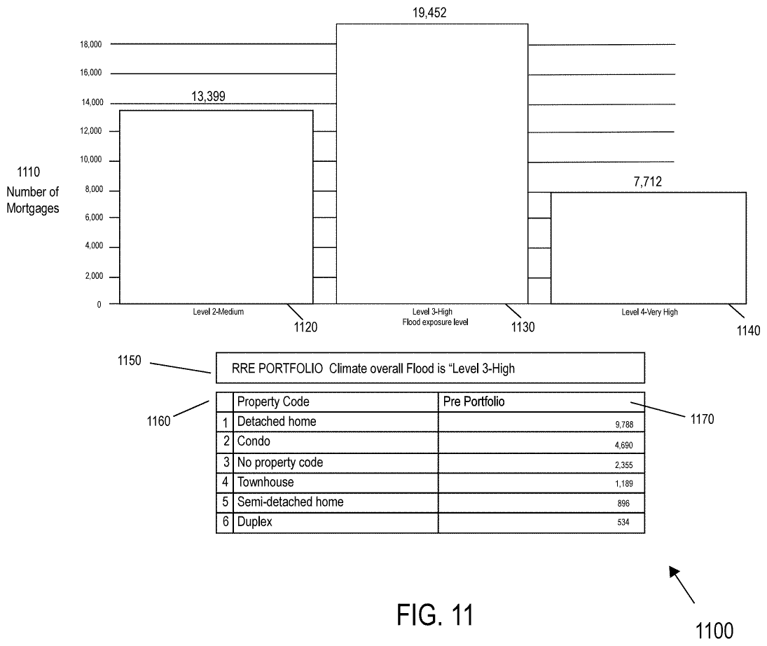

FIG. 11 shows a chart 1100 of summary analysis of flood hazard exposure of residential real estate (RRE) mortgage assets of a sponsoring enterprise. 1110 is a columnar chart of number of mortgage assets for various levels of flood hazard risk exposure. 1120 (level 2—medium flood exposure level), 1130 (level 3—high flood exposure level), and 1140 (level 4—very high exposure level), are columns representing number of mortgages at various levels of flood exposure risk. A user can select a column to examine in further detail the column for summary of the property types exposed. Table 1150 displays data for property types exposed for level 3—high flood exposure level including column 1160—property type exposed, and column 1170— number of RRE assets.

FIG. 12 shows execution steps of a method for generating visual representations of climate hazard risk. The illustrative method 1200 shown in FIG. 12 comprises execution steps 1202, 1204, 1206, and 1208. However, it should be appreciated that other embodiments may comprise additional or alternative execution steps, or may omit one or more steps altogether. It should also be appreciated that other embodiments may perform certain execution steps in a different order; steps may also be performed simultaneously or near-simultaneously with one another.

In an embodiment of step 1202, the computer receives input or selection of a real estate asset file including geolocations data extracted from a real estate assets portfolio database of an enterprise. An input or selected real estate asset file may further include data enrichment of the geolocations data extracted from the real estate assets portfolio database of the enterprise. In some embodiments, a user may input or select a file. In other embodiments, the computer may be configured to input or select the file, or the computer may be programmed to obtain the data from the file from a local or remote location.

In an embodiment of step 1204, the first graphical user interface dashboard displays a geo-region selection control that defines outer latitude and longitude boundary lines of the second geographic region. A climate hazard parameter selection may include one of a plurality of climate hazard types, and a probability that the one of the plurality of climate hazard types will happen over a selected time frame. In an embodiment in which the climate hazard risks include flood hazard risks, the climate hazard parameter selection may include one of fluvial flooding, pluvial flooding, or coastal flooding.

In an embodiment of step 1206, the method further includes the step, in response to receiving the geo-region selection and the climate hazard parameter selection (e.g., a manual or automatic selection), of generating a third graphical user interface dashboard configured to display on the client computing device a climate hazard estimate map. The climate hazard estimate map provides a visual representation of climate hazard within the second geographic region corresponding to the geo-region selection and the climate hazard parameter selection. At step 1208, the climate hazard risk map may include an overlay of the climate hazard estimate map and a real estate assets map comprising a visual representation of the geolocations data for at least a portion of the plurality of real estate assets within the second geographic region.

In an embodiment of step 1208, the visual representation of climate hazard risks within the second geographic region includes a spatial visualization of geo-regions having relatively high probability of climate hazard. In an embodiment of step 1208, the visual representation of climate hazard risks includes metadata describing climate hazard risks associated with given geographic regions or geo-locations within the second geographic region associated with one or more of the plurality of real estate assets.

In various embodiments of step 1208, the geolocations data for the plurality of real estate assets include one or more of geo-coordinates, geolocations data that define geographic boundaries, and geolocations data including latitude and longitude values. In various embodiments, the geolocations data for the plurality of real estate assets includes one or more of geolocations data associated with postal codes, geolocations data associated with collections of proximate postal zones, geo-coordinates associated with centers of postal zones, and geo-coordinates defining boundaries of postal zones.

Foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as addition, the order of the operations may be rearranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage, or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
generating, by the computer, a first graphical user interface dashboard configured to display on a client computing device a climate hazard selection map encompassing a first geographic region;
receiving, by the computer, a geo-region selection and a climate hazard parameter selection, wherein the geo-region selection defines boundary of a second geographic region within the first geographic region; and
in response to receiving the geo-region selection and the climate hazard parameter selection, generating, by the computer, a second graphical user interface dashboard configured to display on the client computing device a climate hazard risk map comprising a visual representation of climate hazard risks within the second geographic region corresponding to the climate hazard parameter selection and geolocations data for a plurality of real estate assets.

2. The computer-based method of claim 1, wherein the geo-region selection defines outer latitude and longitude boundary lines of the second geographic region.

3. The computer-based method of claim 1, wherein the climate hazard parameter selection comprises one of a plurality of climate hazard types, and a probability that the one of the plurality of climate hazard types will happen over a selected time frame.

4. The computer-based method of claim 1, wherein the climate hazard risks comprise flood hazard risks, wherein the climate hazard parameter selection comprises one of fluvial flooding, pluvial flooding, or coastal flooding.

5. The computer-based method of claim 1, wherein the visual representation of climate hazard risks within the second geographic region comprises a spatial visualization of geo-regions having relatively high probability of climate hazard.

6. The computer-based method of claim 1, wherein the visual representation of climate hazard risks comprises metadata describing climate hazard risks associated with given geographic regions or geo-locations within the second geographic region associated with one or more of the plurality of real estate assets.

7. The computer-based method of claim 1, further comprising inputting or selecting a real estate asset file including geolocations data extracted from a real estate assets portfolio database of an enterprise.

8. The computer-based method of claim 7, wherein the inputting or selecting the real estate asset file further comprises data enrichment of the geolocations data extracted from the real estate assets portfolio database of the enterprise.

9. The computer-based method of claim 1, further comprising the step, in response to receiving the geo-region selection and the climate hazard parameter selection. of generating a third graphical user interface dashboard configured to display on the client computing device a climate hazard estimate map comprising a visual representation of climate hazard within the second geographic region corresponding to the geo-region selection and the climate hazard parameter selection.

10. The method according to claim 9, wherein the climate hazard risk map comprises an overlay of the climate hazard estimate map comprising the visual representation of climate hazard within the second geographic region and a real estate assets map comprising a visual representation of the geolocations data for at least a portion of the plurality of real estate assets within the second geographic region.

11. The method of claim 1, wherein the geolocations data for the plurality of real estate assets comprises one or more of geo-coordinates, geolocations data that define geographic boundaries, and geolocations data including latitude and longitude values.

12. The method of claim 1, wherein the geolocations data for the plurality of real estate assets comprises one or more of geolocations data associated with postal codes, geolocations data associated with collections of proximate postal zones, geo-coordinates associated with centers of postal zones, and geo-coordinates defining boundaries of postal zones.

13. A system, comprising:
a non-transitory machine-readable memory that stores a plurality of real estate asset files including geolocations data for a plurality of real estate assets, and climate hazard data; and
a processor, wherein the processor in communication with the non-transitory, machine-readable memory executes a set of instructions instructing the processor to:
generate a first graphical user interface dashboard configured to display on a client computing device a climate hazard selection map encompassing a first geographic region;
receive a geo-region selection and a climate hazard parameter selection, wherein the geo-region selection defines boundary of a second geographic region within the first geographic region; and
in response to receiving the geo-region selection and the climate hazard parameter selection, generate a second graphical user interface dashboard configured to display on the client computing device a climate hazard risk map comprising a visual representation of climate hazard risks within the second geographic region corresponding to the climate hazard parameter selection and geolocations data for a plurality of real estate assets.

14. The system of claim 13, wherein the climate hazard parameter selection comprises one of a plurality of climate hazard types, and a probability that the one of the plurality of climate hazard types will happen over a selected time period.

15. The system of claim 13, wherein the climate hazard risks comprise flood hazard risks, wherein the climate hazard parameter selection comprises one of fluvial flooding, pluvial flooding, or coastal flooding.

16. The system of claim 13, wherein the visual representation of climate hazard risks within the second geographic region comprises a spatial visualization of geo-regions having relatively high probability of climate hazard.

17. The system of claim 13, further comprising a climate hazard dashboard configured to generate one or both a dashboard and a report including the visual representation of climate hazard risk.

18. The system of claim 13, further comprising a cloud data warehouse and a business intelligence (BI) analytics component.

19. The system of claim 18, further comprising a climate hazard dashboard configured to generate one or both a dashboard and a report including the visual representation of climate hazard risk, wherein the BI analytics component acts as intermediary between the climate hazard dashboard and the cloud data warehouse.
